(19) United States
(12) Patent Application Publication
(10) Pub. No.: US 2001/0049040 A1
(43) Pub. Date: Dec. 6, 2001

(54) FUEL CELL SYSTEM FOR AN ELECTRIC VEHICLE

(76) Inventors: HORST GRUNE, LUDMANNSDORF (AT); PETER BUCHNER, HEILIGENSTADT (DE); RITTMAR VON HELMOLT, ERLANGEN (DE)

Correspondence Address: SCHIFF HARDIN & WHITE, Patent Department, 6600 Sears Tower, 233 South Wacker Drive, Chicago, IL, 60606-6473, US

(21) Appl. No.: 09/214,893

(22) PCT Filed: Jun. 30, 1997
(86) PCT No.: PCT/DE97/01372

§ 371 Date: None

(30) Foreign Application Priority Data
Jul. 18, 1996 (DE) 196 29 084.8

(51) Int. Cl. H01M 8/04; B60K 1/00; B60K 11/00

(52) U.S. Cl. 429/26; 429/13; 180/65.3; 180/68.1

(57) ABSTRACT

The invention is directed to a fuel cell system for an electric vehicle that is driven with (at least among other things) fuel cells, whereby the—preferably but not exclusively air-cooled—fuel cell system is installed such that the dynamic pressure of the relative wind drives the cooling system. A fuel cell stack is preferably located at the radiator of the vehicle and the relative wind directly cools the individual fuel cells.

The invention is directed to a drive battery of fuel cells for an electric vehicle as well as to a method for the operation of this fuel cell system.

Up to now, fluid-cooled fuel cells have been mainly utilized as drive batteries in electric vehicles such as, for example, busses or passenger vehicles. The drive battery composed of the individual fuel cells is thereby attached in the electric vehicle above the driven axle, in the cargo space or in the motor chamber. The waste heat of the fuel cells generated during operation is output to the ambient air of the electric vehicle. This technology requires an involved cooling system with fluid cooling and various heat exchangers in the electric vehicle for regeneration of the heated coolant. Not only do considerable design exertions thereby arise but the cooling system also contributes a not inconsiderable part to the overall weight of the electric vehicle and thus increases the energy output minimally required for the traction of the electric vehicle. Due to these disadvantages of the previously practiced fuel cell cooling, there is the need to design a cooling system for a fuel cell system in an electric vehicle that comprises a simpler, just as efficient, more compact and lighter weight cooling.

An electric vehicle with a fuel cell for energy supply is disclosed, for example, by DE-43 22 765 C1.

A hybrid system for the drive of an electric vehicle is disclosed by DE-A 40 01 684. In addition to the electric motor, it also comprises an accumulator and a fuel cell.

It is therefore an object of the present invention to make a mobile fuel cell energy supply with cooling system available for an electric vehicle that places less additional weight on the electric vehicle than has hitherto been standard in this technology and that nonetheless delivers the same performance data.

The subject matter of the present invention is therefore an electric vehicle whose drive battery comprises a fuel cell system with a potentially secondary cooling system through which a gaseous coolant flows, whereby the fuel cell system is arranged such that the potentially secondary coolant is entirely or partially introduced into the cooling system of the fuel cell system by the dynamic pressure of the relative wind.

Within the scope of the invention, the dynamic pressure of the relative wind that acts on the electric vehicle during travel can effect the flow of the coolant through the cooling system or can be exploited for increasing the flow velocity of the coolant through the cooling system of the fuel cell system.

Another subject matter of the invention is a method for electro-traction with a drive battery that comprises a fuel cell system with a potentially secondary cooling system, whereby the energy acquired from the relative wind is converted in the cooling system.

Further advantageous developments of the invention derive from the subclaims as well as from the description and from the exemplary embodiments.

In one development of the invention, another pressure source such as, for example, a fan is used in addition to the relative wind in order to conduct the potentially secondary coolant through the potentially secondary cooling system.

In one embodiment of the invention, the drive battery of the electric vehicle is composed of fluid-cooled fuel cells, whereby the waste heat of the fuel cells (up to 60%) is first transmitted to a fluid coolant that is then cooled with the relative wind in a heat exchanger.

In another development of the invention, the drive battery of the electric vehicle is composed for example air-cooled fuel cells and the relative wind can be directly supplied into the cooling system of the fuel cells.

In an advantageous development of the invention, the fuel cells of the drive battery are composed of PEM fuel cells, whereby PEM stands for polymer electrolyte membrane.

A preferred embodiment of the invention is the arrangement wherein the air-cooled fuel cell system is installed directly at the cooler. It can thereby be advantageous when the fuel cell system is protected by a solid bumper attached in the foremost front area of the vehicle.

The air-cooled fuel cell system is especially preferably installed such in the electric vehicle that the plane normals onto the active surfaces of the individual fuel cells reside perpendicular to the direction of travel, so that the relative wind flows parallel to the active surfaces.

Any propulsion means driven with an electric motor is referred to as “electric vehicle”, whereby the bed on which it travels, i.e. road, rail, water, snow or sand, etc. plays no part. What is critical is that the electric vehicle is driven with a drive battery.

What is understood as “drive battery of an electric vehicle” is a mobile energy supply system that is at least partly composed of fuel cells. Supporting the fuel cells, other means for energy generating such as other batteries or the like can thereby also be utilized. Inventively, the drive battery need not be exclusively composed of fuel cells but must contain fuel cells.

What is referred to as “dynamic pressure of the relative wind” is the pressure that takes effect as dynamic pressure due to the movement of the vehicle through the ambient air (pₛ=ρ_{L}/2 V²). A fan, a compressor or the like can serve as further “pressure source” with which the cooling system is supplied with gaseous coolant, usually composed of air.

All types of fuel cells that come into consideration for mobile energy delivery can be utilized as “fuel cells”. The PEM fuel cell and the direct-methanol fuel cell are thereby in the foreground.

Referred to as “primary cooling system” or “normal cooling system” is a cooling system wherein the coolant (fluid or relative wind) flows directly over the bipolar plates of the fuel cells and absorbs the waste heat of the fuel cells.

What is referred to as “secondary cooling system” is a cooling system in which a heated coolant (because employed in a primary cooling system) is cooled and, thus, regenerated.

What is referred to as “air-cooled fuel cell” is a fuel cell wherein the primary cooling is possible with the relative wind. The relative wind is thereby supplied into the cooling system of the fuel cell with its predetermined dynamic pressure and can also be additionally supported by a further, independent gas or fluid stream.

A drive battery is preferably utilized whose arrangement in the outer area of the electric vehicle is such that the relative wind by itself is adequate in order to assure the air cooling of the drive battery composed of fuel cells. A supporting ventilator fan can be utilized for low travel speed or high outside temperature, as in traditional vehicles powered by an internal combustion engine.

What is referred to as “outer area of the electric vehicle” is the entire exterior of the electric vehicle. This term is thus not limited to the front of the vehicle; it is definitely conceivable that the drive battery is located at the top on the roof or down below under the passenger compartment or cargo space of the electric vehicle. What is critical in the outer area of the electric vehicle is that the relative wind acts directly on it. The arrangement will thereby often arise that the drive battery is installed in the vehicle at the location of a traditional radiator. In this case, it is advantageous when a solid bumper as known, for example, from all-terrain vehicles and that can be formed of thick steel pipes is attached preceding the drive battery, so that this is protected against damage given minor collisions.

An optimum utilization of the dynamic pressure of the relative wind occurs when the plane normals of the active surfaces of the fuel cells reside perpendicular to the direction of travel. The relative wind can thereby flow along the cell plates and act directly as coolant. Given attachment of the heat exchanger of a fluid-cooled drive battery in the relative wind of the electric vehicle, the active surfaces are also correspondingly aligned parallel to the flow direction of the relative wind. It is thereby obvious that there are two possibilities for this parallel alignment relative to the relative wind, namely, first, the possibility that the cell is vertically attached and, second, the possibility that it is horizontally attached. Expressed differently, the individual fuel cells of the “stacks” (i.e. the cell stack of the fuel cells in the drive battery) can be stacked both from top to bottom as well as from left to right. Likewise, the individual active surfaces of the heat exchanger can be stacked from top to bottom or from right to left.

What is referred to as “waste heat” of a fuel cell is the heat that is released in the conversion at the fuel cell and that is not used. Since fuel cells are usually operated with a thermodynamic efficiency of less than 60%, waste heat on an order of magnitude of >40% of the chemical energy introduced into the fuel cell likewise usually occurs. Given fluid-cooled fuel cells, this thermal energy or waste heat is first output to a fluid coolant such as, for example, water. The fluid coolant thereby flows around individual fuel cells of the drive battery and is moved in circulation, i.e. regenerated via a heat exchanger connected to the fuel cell stack, i.e. cooled and re-introduced into the fuel cell stack. Inventively, the relative wind is then utilized in the operation of the heat exchanger wherein the coolant is regenerated.

The bipolar plates of the fuel cells are the terminating plates of the individual fuel cells above or below the cathode or anode space that simultaneously enable the electrical conduction within a fuel cell stack. Given fluid-cooled fuel cells, the coolant flows between the bipolar plates of the individual fuel cells and, given air-cooled fuel cells, the relative wind flows in the same intervening space.

What is referred to as “active surface” of a fuel cell is the surface in which either the electrolyte or the electrodes are located or, respectively, along which the reaction agents such as, for example, oxidant and fuel flow.

The invention is also explained in greater detail below on the basis of two exemplary embodiments of air-cooled fuel cell system in vehicles that are inventively preferred.

### 1^{st} EXAMPLE

A cell with 300 cm² active area is quadratic with an edge surface of 210 mm and a thickness per cell of approximately 4.5 mm. Respectively 100 of these cells are united to form a block or stack, whereby an end plate approximately 2 cm thick that holds the individual cells of the fuel cell stack together is also respectively secured to the block/stack at the front and back. Two blocks of respectively 100 cells each yield a cuboid that is 42 cm high, 21 cm deep and 49 cm wide. Such a cuboid has an overall output of 15 kW given an output of 0.25 W/cm². This output suffices in order to be installed in a compact car and to pull it, and the cuboid also has the dimensions that it can be well-integrated into the electric vehicle front of a compact car where the radiator is usually seated.

2. Two blocks of cells with 400 cm² each that are stacked with 150 cells have a width of 72 cm given an output of 42 kW when an output of 0.35 Watts is achieved per cm². Such a stack or such a drive battery is mounted in a mid-size car transversely above the front axle, where it can be easily supplied with cooling air, on the other hand, and, on the other hand, is well-protected against damage given minor accidents.

Since the heat density (i.e. the heat per unit of area that is generated or to be eliminated) of a fuel cell is comparatively slight and uniform compared to a traditional internal combustion engine, all of the arising heat of the fuel cell block (=of the drive battery) can be eliminated directly to the ambient air without great outlay given suitable guidance of an air stream.

The air-cooled fuel cell batteries respectively installed in a vehicle, as described in the examples, make use of this consideration. When the relative wind promotes the cooling airflow, what is altogether the energetically most beneficial cooling is possible with this arrangement at a given operating temperature. Dimension and weight of each fuel cell system approximately corresponds to the heat exchanger coolant/air of a traditional vehicle, which can be inventively eliminated. The air-cooled fuel cell battery makes the lowest power-weight ration and the lowest power-volume ration possible because all other solutions must be fundamentally made heavier and bigger merely because of the heat exchanger that is otherwise necessary.

1. Electric vehicle whose drive battery comprises a fuel cell system, whereby the fuel cell system comprises at least an integrated primary cooling system through which a gaseous coolant flows, characterized in that the fuel cell system is arranged such that the dynamic pressure of the relative wind entirely or partly drives the coolant into the cooling system.

2. Vehicle with fuel cell system according to claim 1, whereby another pressure source, for example a fan, is also used in addition to the dynamic pressure in order to conduct the coolant through the cooling system.

3. Vehicle with fuel cell system according to claim 1 or 2, whereby a further primary cooling system with fluid coolant is provided, whereby the fluid coolant, after being heated in the primary cooling system, is cooled and regenerated in a secondary cooling system by a secondary coolant.

4. Vehicle with fuel cell system according to claim 3, whereby the secondary cooling system comprises a heat exchanger.

5. Vehicle with fuel cell system according to one of the preceding claims, whereby the fuel cell system comprises PEM fuel cells.

6. Vehicle with fuel cell system according to one of the preceding claims, whereby the fuel cell system is arranged in the cooler, i.e. in the foremost front region of the electric vehicle.

7. Vehicle with fuel cell system according to one of the preceding claims, whereby the fuel cell system is arranged over the driven axle of the electric vehicle.

8. Vehicle with fuel cell system according to one of the preceding claims, whereby the fuel cells are installed such in the fuel cell system of the electric vehicle that the plane normals of the active surfaces of the individual fuel cells reside perpendicular to the direction of travel.

9. Method for the operation of a fuel cell system for an electric vehicle according to one or more of the claims 1 through 8, characterized in that the energy acquired from the dynamic pressure of the relative wind is utilized for complete or partial introduction of the gaseous coolant into the cooling system.
